(19) United States
(12) Patent Application Publication
(10) Pub. No.: US 2011/0254196 A1
(43) Pub. Date: Oct. 20, 2011

(54) METHOD FOR MAKING AN ACOUSTIC ATTENTUATION PANEL, IN PARTICULAR FOR AERONAUTICS

(75) Inventors: Guy Bernard Vauchel, Harfleur (FR); Guillaume Ruckert, Fiquefleur-Equainville (FR)

(73) Assignee: AIRCELLE, Gonfreville L'Orcher (FR)

(21) Appl. No.: 13/141,333

(22) PCT Filed: Aug. 26, 2009
(86) PCT No.: PCT/FR2009/001033

§ 371 Date: Jun. 22, 2011

(30) Foreign Application Priority Data
Dec. 22, 2008 (FR) 08/07349

(51) Int. Cl. B29C 71/02

(52) U.S. Cl. 264/236

(57) ABSTRACT

The invention relates to a method for making an acoustic attenuation panel, comprising using at least one foam block (1), coating at least the acoustic surface of said foam block (1) with a fresh composite material (9), and making perforations (27; 27a, 27b, 27c, 27d, 27e) in the resulting coating.

### TECHNICAL FIELD

The present invention relates to a method for making an acoustic attenuation panel, notably for aeronautics.

### BACKGROUND

Acoustic panels with a honeycomb core sandwiched between an acoustic skin provided with perforations and a supporting skin are known from the prior art.

The acoustic skin, generally made in a composite material has to be polymerized and then pierced in order to be assembled on the honeycomb core: a fresh drape of this skin on the core cannot actually be contemplated because of the risk of occurrence of facets caused by the cells of the core during the pressing of this core on the acoustic skin (“telegraphing” phenomenon); further, piercing of this skin after its polymerization on the core would inevitably lead to the damaging of certain portions of the core.

Therefore specific tooling for forming the acoustic skin has to be provided as well as a particular manufacturing cycle for this preliminary step.

Further, the acoustic skin during the adhesive bonding phase with the core has holes which are clogged by the adhesive or the resin, reducing the effective surface area for sound attenuation treatment.

### BRIEF SUMMARY

The invention intends to notably to do without such specific tooling and such specific manufacturing cycle.

This is achieved with a method for making an acoustic attenuation panel in which at least one block of foam is taken, at least the acoustic face of this foam block is coated with a fresh composite material, and perforations are made in the thereby produced coating.

By means of this method, it is therefore no longer necessary to provide a preliminary phase or specific tooling for making (by polymerization plus piercing) the acoustic skin: in fact it is the foam block which by its relative rigidity forms the tool for molding the acoustic skin, without any risk of occurrence of facets (since the foam block is solid, unlike the cells of the honeycomb).

Because of the use of a foam block as an acoustic attenuation material, making perforations in the composite material once it is placed on the foam block has no consequence on the acoustic performances of the panel: indeed, assuming that a portion of the foam is affected by these perforations, the quality of absorption or the integrity of the foam block is by no means affected unlike what may happen if the cells of a honeycomb structure were damaged.

Further it will be noted that because of the fresh coating of the acoustic face of the foam block by means of a composite material, migration of the resin in the thickness of the foam block may occur, which allows an intimate connection of the acoustic skin with the foam block.

According to other optional features of the method according to the invention:
it is proceeded with fresh draping of said composite material on said foam block, i.e.
   A) said composite material is freshly draped on a mold with a shape mating the one of the acoustic face of said foam block,
   B) the acoustic face of said foam block will be applied on this mold,
   C) the foam block is subject to pressure against the mold,
   D) said composite material is polymerized,
   E) the thereby polymerized acoustic face is perforated;
prior to step B), the opposite face of the foam block is also draped, by taking care to have the composite material folds applied on both faces jut out and be joined;
countermolds are optionally used for ensuring the cohesion of the composite material folds on the edges of said foam block;
it is proceeded with overmolding of said composite material on said foam block, i.e.:
   A) the said composite material block is placed between both halves of a mold, by making a space notably between the acoustic face of said block and one of the two mold halves,
   B) an optionally loaded thermoplastic or thermosetting resin is injected into the space defined by said half-molds,
   C) said perforations are made in the composite material on the side of the acoustic face of the foam block;
both half-molds are rigid;
said one half-mold is rigid and the other half-mold is formed by a bladder capable of being put in vacuo;
said perforations are made by molding said composite material, by means of the studs formed on one of the half-molds or on the acoustic face of the foam block;
the perforations are made by piercing said polymerized composite material after opening said mold;
said acoustic panel is made by means of several foam blocks;
through-orifices are provided in said foam block, so as to allow casting of reinforcements in composite material extending between both faces of the foam block.

### BRIEF DESCRIPTION OF THE DRAWINGS

Other features and advantages of the present invention will become apparent in the light of the description which follows, and upon examining the figures appended herein, wherein:

FIGS. 1 to 6 illustrate in a sectional view, different steps of a first alternative of the method according to the invention,

FIGS. 7 to 16 illustrate, in a sectional view, (except for FIGS. 12a and 12b, which illustrate a top view of the element illustrated in FIG. 12), the different steps of a second alternative of the method according to the invention, and

FIGS. 17 to 21 illustrate different options of the method according to the invention, applicable both to the aforementioned first and second alternatives.

### DETAILED DESCRIPTION

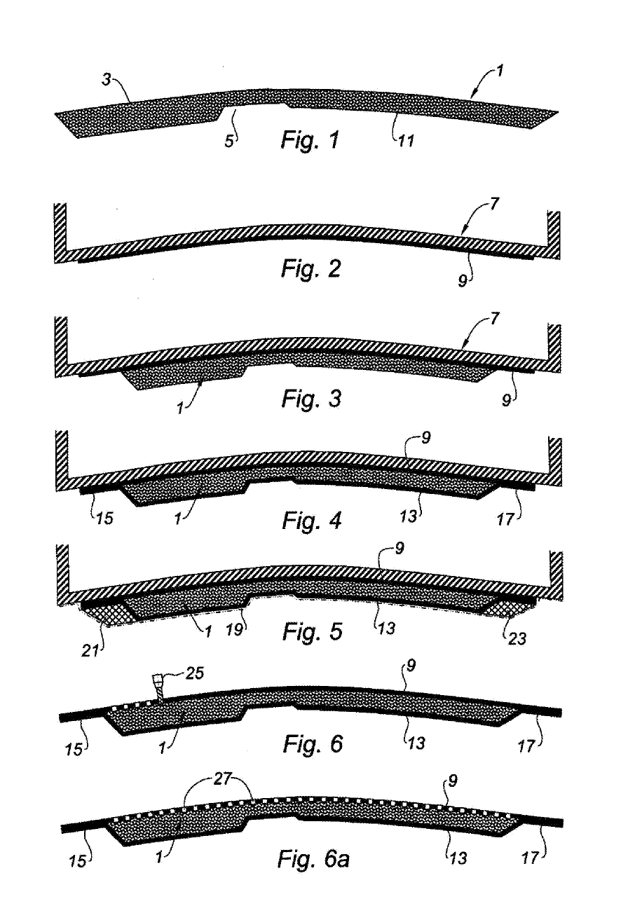

Referring now to FIG. 1, a foam block 1 may be seen, substantially appearing in the form of a curved foam plate.

The foam which is relevant to the present invention is a relatively rigid material having an open structure, having many communicating cells, imparting to this material acoustic absorption characteristics.

This foam may be formed from metal, polymer, ceramic or composite material available on the market.

The following table gives different examples of foams which may be used, notably depending on the thermal constraints to which the panel will be subject:

| | | Examples of foams |
|---|---|---|
| Characteristics | Nature of the foams | available on the market. |
| Foams withstanding | Foams based on a nickel | RECEMAT ® - marketed |
| relatively high | chromium alloy - density | by RECEMAT |
| temperatures (up to 600° C. | from 0.6 to 0.65 g/cm³ | INTERNATIONAL, or |
| and beyond) | Carbon foam - may be | metal foams from |
| | resistant beyond 600° C. | FiberNide |
| Foam withstanding | Foams based on aluminium - | Foams from CYMAT |
| relatively low temperatures | density from 0.2 to 0.4 g/cm³ | |
| (up to 200° C.) | Foams in polymethacrylimide - | ROHACELL 51 ® - |
| | density of 0.05 g/cm³ | marketed by EMKAY |
| | | PLASTICS |
| Foams having relatively | Foams based on nickel - a | |
| high heat conductivity | conductivity which may reach | |
| | 9 W/mK for a minimum | |
| | porosity of 90% | |
| | Foams based on an | |
| | aluminium and copper alloy - | |
| | a conductivity which may | |
| | reach 10 W/mK for a minimum | |
| | porosity of 65% | |
| | Carbon foam - a conductivity | |
| | which may reach 25 W/mK for | |
| | a minimum porosity of 78% | |
| Foams having relatively | Ceramic foam - a | |
| low heat conductivity | conductivity ranging from | |
| | 0.01 to 1 W/mK for a density | |
| | ranging from 0.02 to 0.4 g/cm³ | |
| | Polymethacrylimide foam - a | ROHACELL 31 ® |
| | conductivity of 0.031 W/mK | marketed by EMKAY |
| | for a density of 0.032 g/cm³ | PLASTICS |

In the case selected for illustrating the present invention, the foam block 1 is intended to absorb acoustic waves in an area of an aircraft engine nacelle, but it is obvious that this example is by no means limiting.

The acoustic face 3 of the foam block 1, i.e. the face of this foam block which is intended to be exposed to the sound source, the acoustic energy of which should be absorbed, is in this case located towards the top of the sheet of drawings, appended herein.

As this may be seen in FIG. 1, the foam block 1 has a specific shape which may notably incorporate one or more cavities 5, making this foam block suitable for a particular installation inside an airplane engine nacelle.

According to a first alternative of the method according to the invention, in order to make an acoustic attenuation panel from the foam block of FIG. 1, it is proceeded as follows.

On a tool 7, the curve of which corresponds to that of the acoustic face 3 of the foam block 1, an organic material impregnated with resin will be freshly draped.

The organic material may typically comprise carbon fibers and the resin may typically comprise an epoxy resin.

The foam block 1 will then be flattened against this draped material 9.

On the face 11 of the foam block opposite to the acoustic face 3, one or several other layers 13 of a fresh composite material will then be draped (FIG. 4), preferably so that the folds of composite material jut out from the foam block 1 and may be joined in the peripheral areas 15, 17 of this foam block.

A bladder 19 inside which a vacuum is applied (FIG. 5) will then be applied on the thereby formed assembly: this has the effect of firmly flattening the composite material folds 9, 13 and the foam block 1 against each other.

If necessary, as this is visible in FIG. 5, countermolds 21, 23 may be provided at the periphery of the foam block 1, so that the vacuum application bladder 19 exerts a sufficient pressure force on the joining area 15, 17 of the composite material folds 9, 13.

The thereby obtained assembly is then put into an autoclave and polymerized at a temperature suitable for the resin used.

Of course, the use of a resin which does not require passing into an autoclave and which allows polymerization at room temperature may also be contemplated.

After polymerization of the folds 9 and 13, it is possible to proceed with operations for piercing the acoustic skin formed by the fold 9 (FIG. 6). To do this, a drilling tool may be used, with which perforations may be made in all or part of the acoustic skin 9, as this is visible in FIG. 6a. It should be noted that during the application of the folds 9, 13 onto the foam block 1, migration of the resin of these folds occurs towards the foam forming the block 1.

This migration is of interest since it allows an intimate association of the composite material folds with the foam, and therefore excellent cohesion of the assembly.

The perforation made by means of the tool 25 (FIG. 6) will have to take into account the migration thickness of the resin into the foam, so as to allow perfect communication between the outside of the thereby made acoustic panel and the foam forming the block 1.

Once the perforations have been made in the acoustic skin, the obtained panel may be set into place for example inside an engine nacelle, for example in the area of the air intake lip of this nacelle or further on the cowl of the engine.

In the second alternative illustrated in FIGS. 7 to 16, one starts again with a foam block similar to the one of FIG. 1 (FIG. 7).

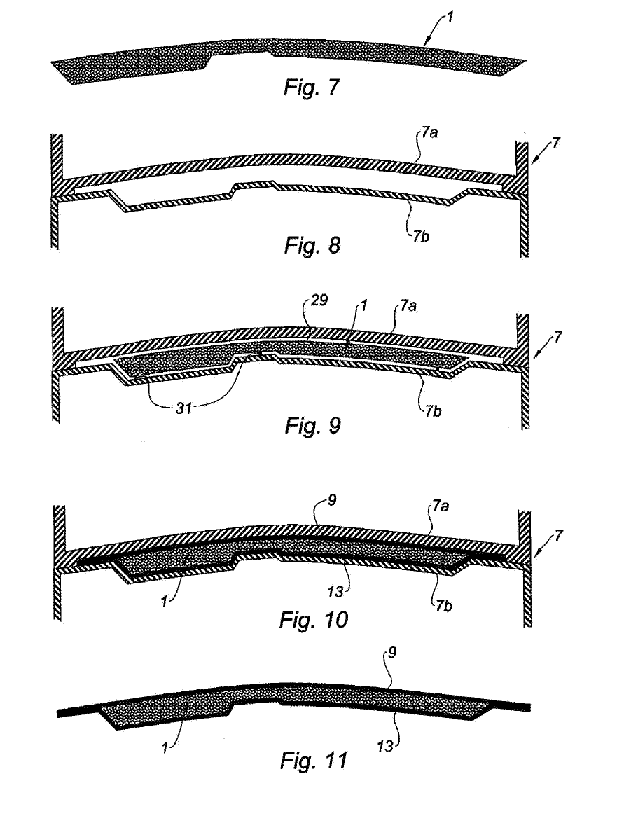

A molding tool 7 is used, comprising two rigid half-molds 7a, 7b, the shapes of which are adapted in order to fit those of the foam block 1, while making an interstice 29 at least between the acoustic face of the foam block 1 and the associated half-mold 7a (FIG. 9).

In the example illustrated in FIG. 9, the interstice 29 extends over both faces of the foam block 1, the studs 31 being used for maintaining a gap between the lower face (i.e. opposite to the acoustic face) of this foam block 1 and the associated half-mold 7b.

From the situation of FIG. 9, a resin such as epoxy resin optionally supplemented with one or several fillers, is injected into the interior of the mold 7. Polymerization of this resin is then carried out, either in an autoclave or at room temperature, depending on the nature of the selected resin.

One then ends up with the table of FIG. 11, in which the resin polymerized in the previous step produces the acoustic skin 9 and the skin 13 located on the opposite face of the foam block 1.

It will be noted that in the case when it is desired that the skins be reinforced with fibers, coating the foam block 1 with a sock of fibers may be considered in the step illustrated in FIG. 9.

Another possibility (not shown) for this second alternative is to use a rigid half-mold and a flexible half-mold, the latter being adapted in order to achieve application of a vacuum in the space located between both half-molds: a suitable exemplary flexible half-mold may be a vacuum bladder.

This particular case in which a rigid half-mold is used is a particular application of the VARTM (Vacuum Assisted Resin Transfer Molding) method: see for example the site:

http://engr.ku.edu/˜rhale/ae510/ websites_f 02/vartmwebsite/.

From the step illustrated in FIG. 11, it is possible to achieve piercing of the acoustic skin 9 under the same conditions as those discussed within the scope of the previous alternative (see FIGS. 6 and 6a).

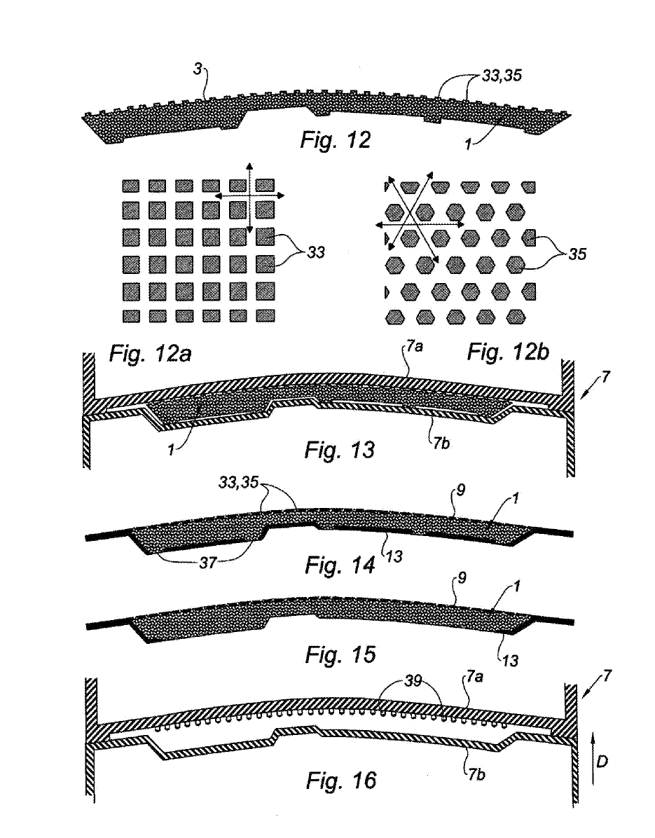

Another alternative for making perforations inside the acoustic skin 9 is illustrated in FIGS. 12 to 16.

In the example illustrated in FIGS. 12 to 13, the foam block 1 is machined so that its acoustic face is provided with a pattern of rectangular 33 (FIG. 12a) or hexagonal 35 (FIG. 12b) foam pads or of any other suitable shape.

It is understood that with this type of pattern, when the foam block 1 is placed inside the mold 7 (FIG. 13), the resin injected into the interior of the mold will extend between the recessed portions defined by the pads 33 and 35.

Thus, after polymerization, an acoustic skin 9 is obtained on which the foam pads 33, 35 are flush, thereby achieving the desired communication between the foam forming the block 1 and the sound emission source.

FIG. 14 further shows that it may be contemplated that maintaining the foam block 1 away from the half-mold 7 b is not achieved with the studs 31 as this is illustrated in FIG. 9, but with heel pads 37 between which the resin spreads out defining the skin 13 opposite to the acoustic skin 9.

FIG. 15 further shows another alternative in which only the edges of the face of the foam block opposite to the acoustic face define an interstice with the mold 7b, so that the skin 13 opposite to the acoustic skin 9 only extends to the periphery of the foam block 1.

FIG. 16 illustrates an alternative embodiment of the perforations in the acoustic skin of the panel according to the invention: in this alternative, the pads 39 are integral with the rigid half-mold 7a, so as to define perforations in the acoustic skin 9 upon injection of resin into the interior of the mold 7.

The length of these pads is designed so as to penetrate sufficiently deeply into the interior of the foam forming the block 1, taking into account the migration of the resin inside this foam block.

It will be noted that the orientation of the pads 39 is substantially parallel to the mold removal direction D of the molding tool 7; in the particular case when the acoustic surface of the foam block is curved, as this is illustrated in FIG. 7, the section of these pads will be designed so that the perforations made in the acoustic skin 9 all have substantially the same section.

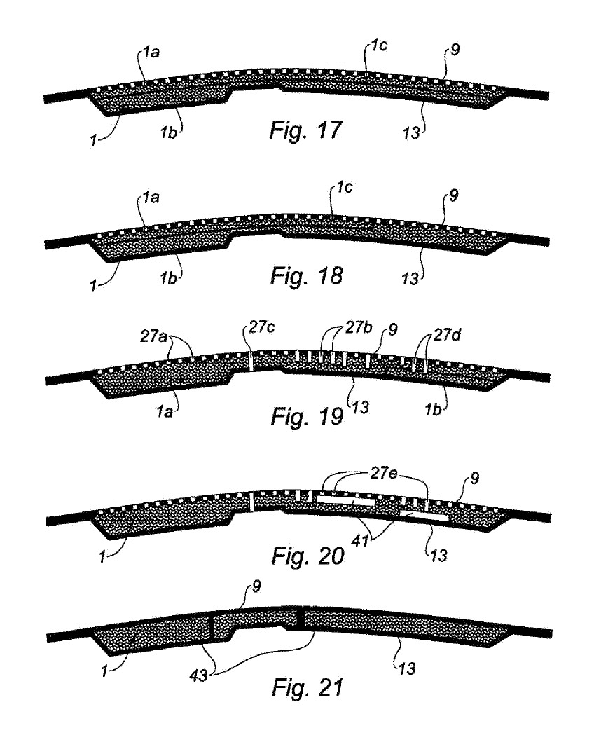

In either one of the alternatives of the method according to the invention which have just been discussed, it is possible to use a foam block in fact formed with a plurality of foam blocks 1a, 1b, optionally having different structural and geometrical characteristics, and which may be superposed or placed side by side, as this is illustrated in FIGS. 17 and 18.

A porous wall 1c may optionally be interposed between these different foam blocks 1a, 1b.

It will be noted that both in the first and in the second alternative, orifices 27a, 27b of different depths, or even orifices 27c passing through the foam block 1 or further even orifices 27d attaining another foam block 1b (FIG. 19), or even orifices 27e opening out inside cavities 41 formed in the inside of the foam block 1 (FIG. 20) may be contemplated.

It will also be noted that achieving machinings passing through foam blocks 1 may be contemplated, with which, during the injection of resin, ribs 43 may be made, with which the acoustic skin 9 and the opposite skin 13 may be connected together, and thus particular rigidity may be imparted to the acoustic panel, suitable for certain uses.

As this will have been understood in the light of the foregoing description, the method for making an acoustic attenuation panel according to the invention is particularly simple: unlike the state of the art, it is not necessary to make the acoustic skin beforehand.

The latter is actually obtained by directly freshly coating the foam panel by means of a composite material.

Because of its relatively compact and rigid structure, the foam block may play the role of a molding tool notably for the acoustic skin, and it is therefore not necessary to provide any specific molding tool for making this skin.

Fresh coating of the foam block by means of a composite material gives the possibility of achieving an intimate association of these materials, and therefore excellent cohesion of the assembly.

Further, as this was illustrated previously, it is no longer necessary to take into account the cycle for piercing the acoustic skin before the cycle for making the complete acoustic attenuation panel: this piercing may actually be carried out subsequently (draping alternative or overmolding alternative), or at the same time (overmolding alternative) as the polymerization of the acoustic skin.

Finally it will be noted that the foam block provides a significantly higher compression strength than that which may be provided by a honeycomb structure, so that significantly higher pressures may be applied to this foam block, notably during the vacuum application step illustrated in FIG. 5.

Of course, the present invention is by no means limited to the described and illustrated embodiments, given as simple examples.

1. A method for making an acoustic attenuation panel in which at least one foam block is taken, at least an acoustic face of this foam block is coated with a fresh composite material, and perforations are made in the thereby achieved coating.

2. The method according to claim 1, wherein it is proceeded with fresh draping of said composite material on said foam block, wherein:
A) said composite material is freshly draped on a mold with a shape mating the acoustic face of said foam block,
B) the acoustic face of said foam block is applied on this mold the foam block is subject to pressure against the mold said composite material is polymerized, E) the thereby polymerized acoustic face is perforated.

3. The method according to claim 2, wherein prior to step B), an opposite face of the foam block is also draped by taking care to have folds of composite material applied on both faces jut out and join together.

4. The method according to claim 2, wherein countermolds are used for ensuring cohesion of composite material folds on wedges of said foam block.

5. The method according to claim 1, wherein it is proceeded with overmolding of said composite material on said foam block, wherein:
A) said composite material block is placed between both halves of a mold, by making a space between the acoustic face of said block and one of the two mold halves,
B) an optionally loaded thermoplastic or thermosetting resin is injected into the space defined by said half-molds,
C) said perforations are made in the composite material on the side of the acoustic face of the foam block

6. The method according to claim 5, wherein both half-molds are rigid.

7. The method according to claim 5, wherein one half-mold is rigid and the other half-mold is formed by a bladder to which vacuum may be applied.

8. The method according to claim 5, wherein said perforations are made by molding said composite material, by means of studs formed on one of the half-molds or on the acoustic face of the foam block.

9. The method according to claim 5, wherein the perforations are made by piercing said polymerized composite material after opening said mold.

10. The method according to claim 5, wherein said acoustic panel is made by means of several foam blocks.

11. The method according to claim 1, wherein through-orifices are provided in said foam block, so as to allow casting of reinforcements in composite material extending between both faces of the foam block.
